(19) United States
(12) Patent Application Publication
(10) Pub. No.: US 2006/0129832 A1
(43) Pub. Date: Jun. 15, 2006

(54) Apparatus and method for protecting user password within computer system

(75) Inventors: Scott Sina Abedi, Durham, NC (US); James Patrick Hoff, Raleigh, NC (US); Matthew Paul Lietzke, Cary, NC (US); Charles B. Oxrieder, Raleigh, NC (US); Peter Hamilton Wetsel, Raleigh, NC (US)

Correspondence Address: LENOVO (US) IP Law, Mail Stop ZHHA/B675/PO Box 12195, 3039 Cornwallis Road, RTP, NC, 27709-2195, US

(73) Assignee: INTERNATIONAL BUSINESS MACHINES CORPORATION, ARMONK, NY (US)

(21) Appl. No.: 11/012,363

(22) Filed: Dec. 15, 2004

(51) Int. Cl. H04L 9/00

(52) U.S. Cl. 713/183

(57) ABSTRACT

A logon process to a computer is amended by providing an apparatus and routine which allow a user to verify that a request for the user to insert a password in a dialog box is issued by a legitimate program. As a consequence the invention improves computer system security and makes it much more difficult for rouge programs to gain access to critical and confidential user's information, such as password or the like.

### FIELD OF THE INVENTION

The invention relates to network security in general and in particular to security which prevents acquisition of users' passwords by malicious code.

### BACKGROUND OF THE INVENTION

Even though network security has been steadily improving there are still areas of susceptibility from which hackers can gain access to critical information and use it for malicious purposes. One area of susceptibility occurs during log on process. The critical information includes user's password or pass phrase.

In a conventional log-on process a dialog box is presented on the monitor screen and a prompt for the user to insert a password. If the correct password is entered the user is granted permission to access the application and/or system. If an incorrect password is entered access is denied. Although, this process works well for its intended purpose it has a defect that provides an opportunity for hackers to gain access to a legitimate pass code and subsequently use it in a way detrimental to the owner. The defect is that there is an assumption that the request for password is initialed by a legitimate source; when in fact this may not be. Instead, the request for a password could well be issued by malicious software spoofing a dialog box and tricking a user to type in or otherwise provide private information.

The prior art has recognized the need to protect password and has provided several methodology to do so. For example, Publish Patent Application No. US2004/0030914A, (Inventors: Edward Emille Kelley et al., Publish date: Feb. 12, 2004) describes a set of software processes to defeat the ability of malicious code to record password entered from a keyboard. A background program periodically runs on a client looking for keyboard—hooking programs not on an approved list or keyboard—hooking program known to be malicious modules. If such a keyboard—hooking program is detected it is deleted and the user is notified to take further action such as rebooting and changing the password. Publish Patent Application No. US2003/0226016A1 (Inventors: David Carroll Challener et al., Publish date: Dec. 4, 2003) describes a device to authenticate keystrokes inputted from a keyboard and not from a surreptitious entry of data through keystroke emulation.

It should be noted none of the referenced prior art addresses the area of vulnerability (I.E. obtaining users' password) set forth above. As a consequence there is a need to provide protection that prevents malicious programs from acquiring users' password.

### SUMMARY OF THE INVENTION

The invention authenticates the requestor of a password before the user enters it in a dialog box provided during log-on process.

In particular, the log-on process to a computer system includes a feature that ask a user to enter a predefined code during log-on. The code could be a sequence of key stokes entered through a keyboard or other means through which a user communicates with a computer. Legitimate application programs are registered in a filter driver, interfacing the keyboard or other Input/Output (I/O) device with the operating system. The filter driver intercept the predefined code formulate it into a message which is sent to the program requesting or prompting for user's password. If the program decide that it did issue a dialog box for password entry it issues a message authenticating the request as valid. If it did not issue the dialog box the program issues an alert warning of un-authorize program snoop and possibly disable the system.

The present invention ensures that the dialog box issued for password insertion is from a legitimate program and not from a malicious one masquerading as a legitimate program. This authentication process adds a higher level of trust and security to users.

### BRIEF DESCRIPTION OF THE DRAWINGS

FIG. 1 shows a schematic of a communications network including station on which the present invention is deployed.

FIG. 2 shows a schematic of a station on which the present invention is provided.

FIG. 3 shows a logical partitioning of the station including teachings of the present invention.

FIG. 4 shows a flow chart of the process according to teachings of the present invention.

FIG. 5 shows a flow chart of the invention practiced or provided in the application program.

FIG. 6 shows a block diagram of the control unit including teachings of the present invention.

FIG. 7 shows a logical representation of Authentication Challenge (AC) filter driver according to the present invention.

### DETAILED DESCRIPTION OF THE EMBODIMENT

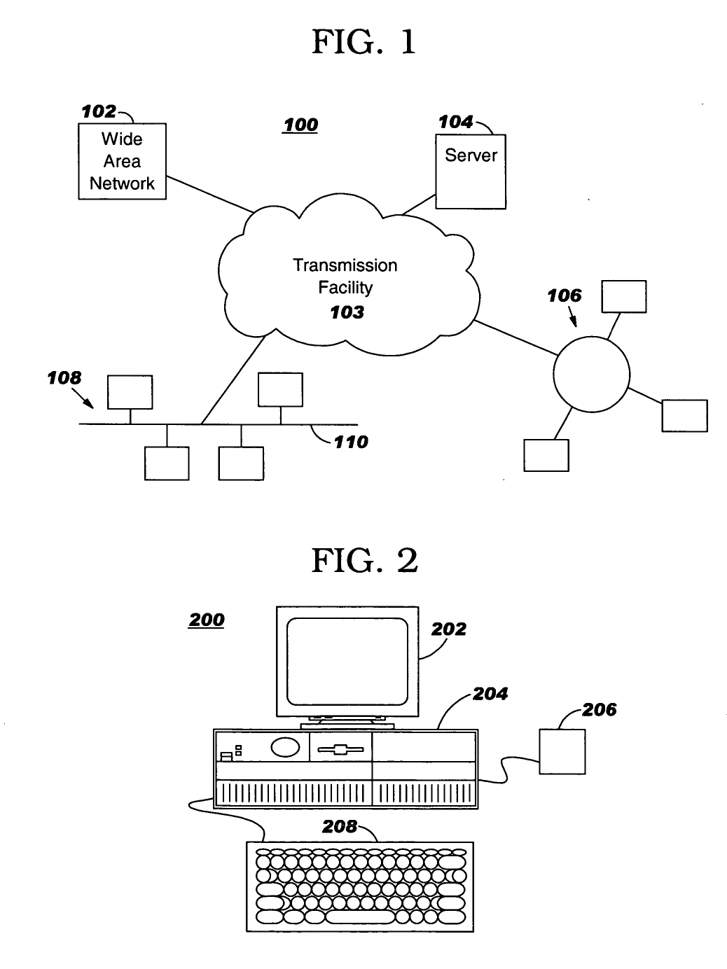

FIG. 1 shows a schematic of communications network 100 with stations in which the present invention, set forth herein, can be deployed. The communications network includes a transmission facility 102 interconnecting a wide area network 102, server 104, local area network (LAN)106 and LAN 108. The transmission facility 102 can be a public switch network such as the internet sometimes referred to as the world wide web (www) or the like. This type of transmission facility has all the necessary components required for any user to access or communicate with any other user connected to the network. This type of communication facility is well known in the art and will not be discussed further. The wide area network 102 includes a communication structure that interconnects a specific area such as a university campus, city or the like couple to the transmission facility 102. Server 104 is connected to the transmission facility 102 and provides service to stations that have access to the server such servers are well known in the technology and further description will not be given. The local area network 106 is of the token ring type and interconnects plurality of stations, shown as rectangular figures, to the transmission facility 102. Each of the stations on 106 can communicate with one another using the coupling ring facility or through transmission facility 102 to access the server 104 or communicate with the other stations on the network. The token ring local area network type is well known in the prior art and further description will not be given. The local area network 108 is of the collision type or ethernet and couples a plurality of stations, shown as rectangular figures, to transmission facility 102. The station on LAN 108 can communicate with one another using media 110 or with other stations in the network using the transmission facility 102. The structure and use of collision type LAN are well known in the prior art and further description will not be given.

FIG. 2 shows a pictorial view of a station that could be used in the local area networks or in the wide area network. It should be noted that the station in FIG. 2 is only one of the several types of stations in which the present invention could be deployed. As a consequence, the station should be constructed as a mechanism to explain the present invention rather than a limitation on the scope of the invention.

Still referring to FIG. 2 the station includes display 202, control unit 204, input/output (I/O) device 206 and keyboard 208. The display 202, I/O device 206 and keyboard 208 are coupled through appropriate communication media to the control unit 204. The I/O device 206 may include mechanism such as a mouse or similar devices used to move a cursor or pointer on display 202. The configuration of station 200 is well known in the prior art and further discussion of its function or components will not be given. In this regard when a user attempts to access or logon to the network using a station or terminal such as the one shown in FIG. 2 a dialog box is posted or displayed on display 202 requesting the user to enter a pass code. If the pass code matches the one in the terminal the user is allowed onto the network, if it does not match the password already in the system the user is denied entry or access. The problem with this procedure is that the user does not know whether or not the dialog was posted by a legitimate application or a rouge program. The present invention disclosed apparatus method and computer programming that allows the user to verify the authenticity of the dialog before a password is entered.

Turning to FIG. 6 for the moment a functional block diagram 600 of control unit 204 is shown. The functional block 600 includes system bus 601, to which CPU or processor 602, ROM 604, RAM 606, video interface 610 and I/O interface 608 are coupled. The ROM store instructions which are used by the CPU 602 to process information. The video interface 610 interconnects display unit 612 to the bus. Likewise, I/O interface 608 coupled with I/O devices such as keyboard, mouse or like devices to the bus 601. RAM 606 contains software including the feature added to allow the terminal to issue a challenge for an application program to prove its authenticity relative to posting dialog in which a user enters a password or other critical information. It should be noted that the software need not to be in the RAM but could be in other storage facilities which is accessible to the CPU. The software in the RAM includes application programs, operating system, keyboard (KBD) device driver including an API which allows the device driver to communicate with the operating system and or the application programs. In order to implement the present invention on the conventional terminal a feature or function called authentication challenge (AC) filter driver, shown enclosed in broken lines, is added to the software contained within RAM 606. In addition, to this function another function 607 is added to the application program which allows it to respond to a challenge raised by a user. The challenge includes a code which is entered by the user through the keyboard or some other type of I/O device. Details of the addition to the application program and the AC filter driver will be given herein after. Suffice it to say the AC filter driver intercepts the code challenge to the display of dialog and causes a message to be forwarded to the application program thus causing it to initiate the routine (describe herein) authenticating issuance of the dialog.

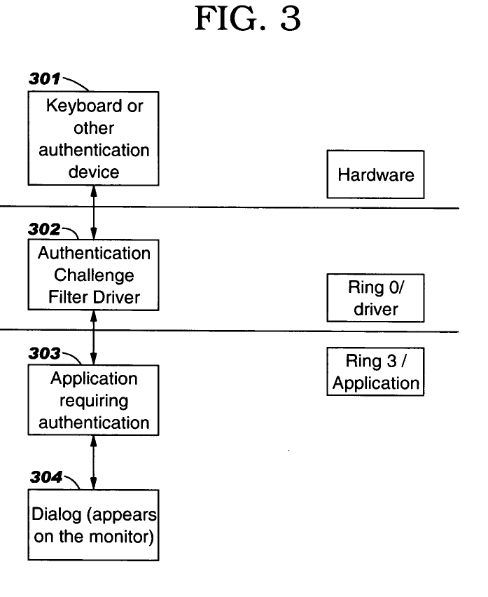

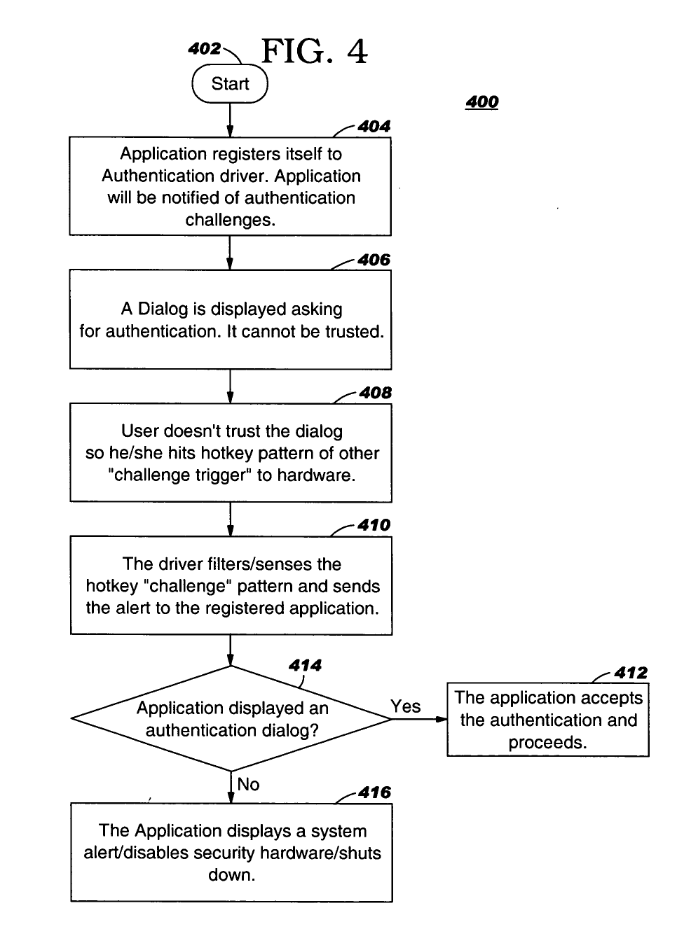

FIG. 3 shows a graphical representation of service architecture according to the teaching of the present invention. The service architecture requires a piece of hardware 301, such as a keyboard or another authentication device. The input from the hardware 301 is fed to an authentication challenge filter driver 302 which is located in the ring 0 level of the terminal. The input from the authentication challenge filter driver 302 is coupled to the application requiring authorization 303 and is shown by posting the dialog 304 on the display or monitor. In this scenario the posting of the dialog for a user to enter pass code is referred to as the application requiring authentication. It should be noted that the authentication challenge driver is placed in the ring 0 section of the terminal. Thus, ring 0 section of the terminal is a secure area available only to administrator or people who are given specific permission to access it. As such hackers cannot input information to compromise the system. On the other hand ring 3 portion of the terminal in which application and dialog are located are available to anyone. As a consequence the openness of ring 3 allows a hacker to post a dialog box thus tricking the user to enter confidential information such as a pass code to which can be used to compromise the system.

Referring again to FIGS. 3 and 6 the keyboard or other input device which is necessary to implement the present invention needs no added functionality. The keyboard or other I/O device is used to generate a code when a user wishes to challenge a dialog display on the 612 or 202. With respect to the hardware being the keyboard a particular set of keys, refer to as hot buttons, would be predefined and the user would activate the predefined key in order to ininate the challenge routine, for example, that key strokes CTRL-ALT-F5 could be one set of code used in relationship to a particular application as will be explained subsequence for multiple applications a different set of key strokes would be required. The authentication challenge filter driver is preferably stationed to intersect the code from the I/O device and determine the application associated with the code and forward the information to the regular keyboard device driver for formulating the message which is sent to the application program.

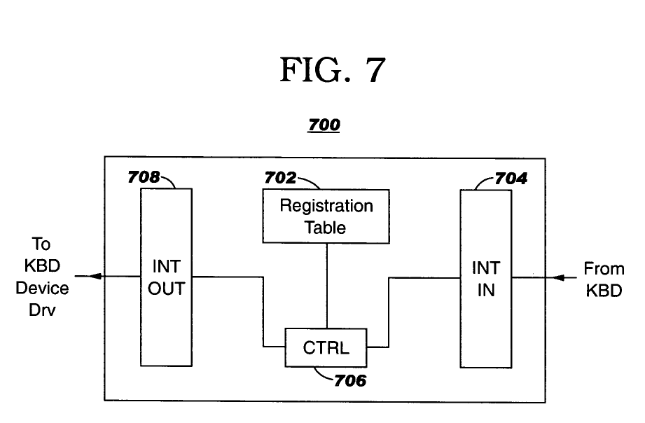

Turning the FIG. 7 for the moment a block diagram 700 of the Authentication challenge (AC) filter driver according to the teaching of the present invention is shown. The driver includes a registration table 702, interface IN (INT IN) 704, controller (CTRL) 706 and interface OUT(INT OUT) 708. The registration table 702 has the format shown in Table 1.

TABLE 1

| Pattern | Application |
|---|---|
| CTRL - ALT- L | Lotus Notes.exec |
| SHIFT -CTRL - Y | CSP.DLL |

Table 1 includes the first column labeled pattern and the second column labeled application. In the pattern column a code representation of a particular hot button key sequence is recorded and the application matching or corresponding to that code is recorded in the column labeled application. For example, if one of the hot button keys is CTRL ALT L it would be recorded in the column labeled pattern. If that hot button series of keys relate to an application named Lotus Notes.exec it would be recorded in the application column but on the same line. Likewise, a code Shift CTRL Y would be on the same line with an application CPS.DLL and so forth. If only one application was running in the system then only one entry would be in the table. With more than one application, each application would be recorded or registered in the table with the corresponding pattern.

Turning to FIG. 7 for the moment input from the keyboard is received in the interface IN 704 and forward to controller 706. Controller 706 use the keystroke pattern from the keyboard and correlates it with entries in the registration table 702. If a match between the input code or pattern and prerecorded code in the registration table occurs, the corresponding application and code is fed through the interface 708 to the regular keyboard (KBD) device driver in RAM 606 (FIG. 6). The keyboard driver uses the regular facilities provided in such driver and formats a message which is forward to the application program for authentication that it did in fact display the dialog box.

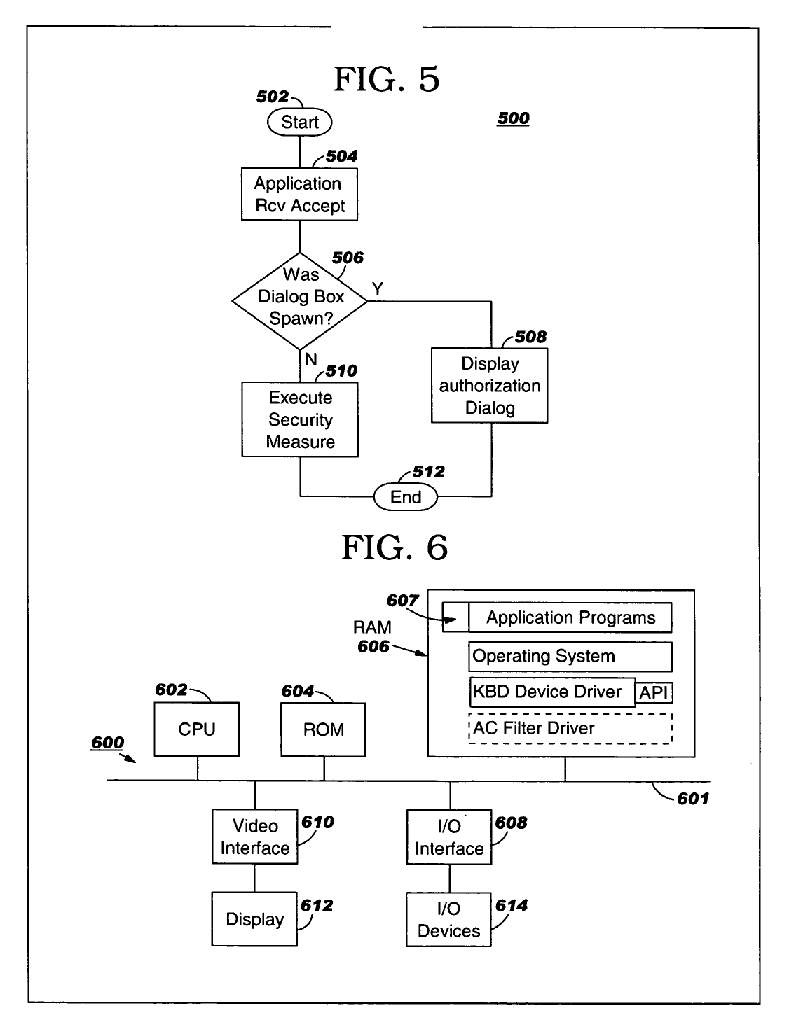

FIG. 5 shows a flow chart 500 of the actions taken by the application program once it receives the message for authentication. The flow chart begins on block 502 and descends onto block 504 where at the application program receives the message termed (Alert). The program then descends into decision block 506 where it tests if a dialog box was spawn. If the program had issued the dialog box, it exits block 506 along the yes path into block 508 where at the program display authentication dialog. Such a dialog would in fact indicate to the user that the program did issue the dialog. If the decision in block 506 is no the program then descends into block 510 where it executes a security measure routine. The security measure routine could be as simple as issuing an alert to the user, shutting the system down or a combination of both. Once the action is completed in either box 508 or 510 the program exit the routine from block 512.

FIG. 4 shows a flow chart of logon process 400 according to the teachings of the present invention. The program begins in block 402 and descends into block 404 where the application 303 (FIG. 3) registers itself to the authentication driver 302 (FIG. 3). The application will be notified in case the related hot button keys are activated. The program then descends into block 406 whereat a dialog 304 (FIG. 3) is displayed on the scene asking for authorization. The dialog asking for authorization is the equivalent of the dialog box requesting the user to enter a pass code. The user, seeing this dialog box, wishes for authorization. The program then descends into 408 whereat the user not trusting the dialog hit the key pattern or other challenge trigger hardware 301. The program then descends to block 410 whereat the driver filters/senses the hot key “challenge” pattern and sends an alert to the registered application in the manor described above. The program then descends into block 414 where the application displays authorization dialog. If the program descends into block 412, the program issued a dialog saying yes the application accepts authorization and proceeds. If the application did not post the dialog the program descends into block 416 where at the application would post an alert and would take protective measures such as shutting the system down etc. The benefit from this invention is that a way is provided in which pass code is protected by the user issuing a challenge to make sure that a dialog for the password did in fact post form a legitimate program.

As described above the application is responsible for reading accurate dialog windows and verify dialog challenges. Dialog challenges are entered by a user who wishes to verify that a dialog for a password is in fact generated by a legitimate program, The challenges initiated by entering (via keyboard or via other I/O devices) certain hot button sequence if the keyboard is the entry device. The keyboard driver would generate the message based upon information from the filter driver. The message is then forward to the application. The application would verify that it has requested authorication and verify challenge as described above. If a Rouge application had sent the dialog instead, the application would recognize that it had not sent the dialog and would take precautions to ensure that the system is not compromised further.

In another scenario the application would execute a dialog requesting that the hot button sequence should be entered by the user. The user presses the keys that will generate a message from the filter driver. The application receives the message, verifies that the challenge is appropriate and then creates the authentication dialog. If a Rogue application requests the hot button sequence it will either not match the known sequence or the correct sequence is pressed and valid application alerted.

While the present invention has been described in the preferred form or embodiment with some degree of particularity, it is understood that this description has been given only by way of example and numerous changes in the detail of construction, fabrication and use including changes in the combination and arrangement of parts may be made without departing from the spirit and scope of the invention.

What is claimed is:

1. A method comprising:
providing a driver module interfacing Input/Output, I/O, devices with an operating system of a computer system;
broadcasting via I/O devices a message asking for authorization from a user logging onto the computer system;
entering a predefined code via one of said I/O devices;
intercepting the predefined code with the driver module which generate a message including the predefined code and forwarding said message to an application program for verification.

2. The method of claim 1 further including receiving the message in said application program;
determining if said application program had issued a dialog box requesting entry of a password by the user;
if said application program had issued the dialog box authenticating the dialog request.

3. The method of claim 2 further including the application program prompting the user via I/O device to enter password.

4. The method of claim 3 further including user entering password, thus completing log-on process.

5. The method of claim 2 further including if said application program had not issued dialog request for password issuing an alert informing user of unauthorize program snoop.

6. The method of claim 5 further including activating security measures.

7. The method of claim 6 wherein the security measures include shut down of the computer system.

8. The method of claim 1 wherein the broadcasting includes displaying the message on a display screen.

9. The method of claim 1 wherein the predefined code includes key strokes inputted from a keyboard.

10. The method of claim 9 wherein key strokes include CTRL_ALT_F5.

11. A method to logon to a computer system including:
receiving in said system a coded indicia indicating desire of a user to access the system;
executing in said system a routine that authenticates identity of a program requesting pass code of the user; and
prompting the user to provide the pass code upon completion of authentication.

12. The method of claim 11 wherein the coded indica includes key strokes from a keyboard.

13. The method of claim 11 wherein the routine includes intercepting the coded indica with a filter driver;
correlating the coded indica with a table positioned in said filter driver, said table containing at least one entry listing an application program paired with a coded value; and
sending a message to the application program if the coded indicia matches the coded value.

14. A method to log-on to a computer system comprising:
receiving a first code requesting verification of a source issuing dialog windows;
executing a routine to authenticate identity of source; and
posting results of the authentication upon completion of the routine.

15. The method of claim (14) wherein the routine includes intercepting the first code;
correlating intercepted code with a table containing at least one entry, listing an application program paired with a second code; and
sending a message to said application program if the interrupted code matches the second code.

16. The method of claim (14) wherein posting includes the application program causing a message legitimizing valid dialog window to be displayed, on a display, if said dialog windows originate from said application program.

17. The method of claim (14) wherein posting includes the application program causing an alert to be issued if said dialog windows did not originate from said application program.

18. The method of claim (14) wherein the alert includes shutting down the computer system.

19. The method of claim (16) wherein legitimizing includes said application program prompting a user to enter a pass code in said dialog windows.

20. A computer system including:
an operating system;
at least one application program operably coupled to said operating system;
a keyboard; and
a filter driver operably interfacing the keyboard and said operating system, said filter driver including a table containing at least one entry listing the application program paired with a coded value and functions to intercept a coded indicia outputted from the keyboard, to correlate the coded value with the coded indicia, to generate a message and to forward said message to the application program, if the coded value matches the coded indicia.

21. The computer system of claim 20 further including a display; and
said application program, in response to the message, causing an alert to be generated on said display if the application program had not issued dialog window for password insertion.

22. The computer system of claim 20 wherein the application program, in response to the message, issues a response authenticating a dialog window for password insertion, if the dialog window ordinated from said application program.

23. A program product comprising:
a medium on which a computer program is recorded, said computer program including instructions to generate a table containing at least one coded value paired with at least one application program; and
instructions, responsive to a code challenging authenticity of a dialog display, to correlate the challenge code with information in said table and to notify said application program of the challenge if the challenge code matches the code in the table.

24. A application program comprising:
A medium on which a computer program is recorded, said computer program including at least one instruction for performing a particular function; and
instructions, responsive to an authentication message, to issue a dialog confirming its identity if said application program had issued a dialog for a password.

25. The computer system of claim 20 wherein the application program includes CSP.DLL.
